(19) United States
(12) Patent Application Publication
(10) Pub. No.: US 2018/0355855 A1
(43) Pub. Date: Dec. 13, 2018

(54) TURBINE WITH FLOW INDUCED BY CRYOGENIC HELIUM

(71) Applicant: GENTUITY ,LLC, Sudbury, MA (US)

(72) Inventor: Papa Abdoulaye MBODJ, Daytona Beach, FL (US)

(73) Assignee: GENTUITY ,LLC

(21) Appl. No.: 15/547,807

(22) PCT Filed: Feb. 11, 2016
(86) PCT No.: PCT/IB2016/050740

§ 371 Date: May 22, 2018

(30) Foreign Application Priority Data
Feb. 23, 2015 (IB) IB2015/051349

(51) Int. Cl. F03G 6/04; F01D 15/10; F25B 13/00

(52) U.S. Cl. CPC F03G 6/04; F05D 2220/36; F25B 13/00; F01D 15/10

(57) ABSTRACT

It is known that up to now there exist turbine systems which although fulfilling the same function as the induced-flow turbine system with cryogenic helium, which is the subject of the invention, present a certain number of technical problems, the high temperature required, up to thousands of degrees Celsius, to operate the thermal turbines that require a compressor and a combustion chamber. The induced flux turbine with cryogenic helium, when driven beyond a critical speed with thermal energy injection, becomes a generator in the image of an AC electric motor which becomes a generator when its rotational speed is greater than the synchronization speed. Thus, the induced flux turbine with cryogenic helium makes it possible to produce electricity and mechanical energy at low temperatures without the use of a mechanical compressor or combustion chamber and makes it possible to operate a reversible cooling system.

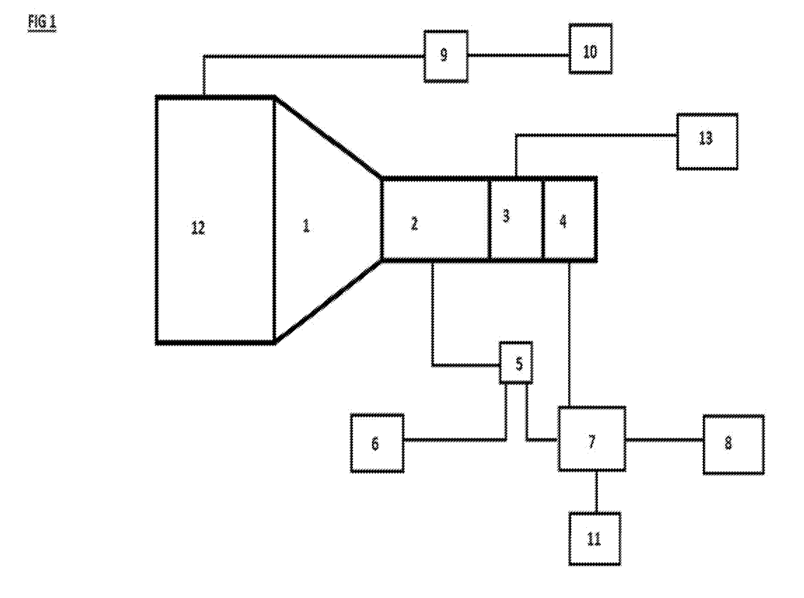

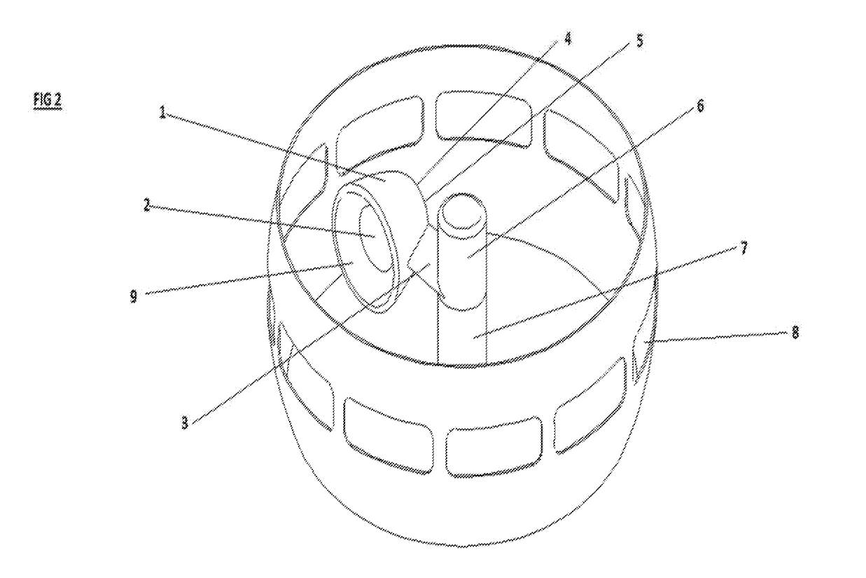

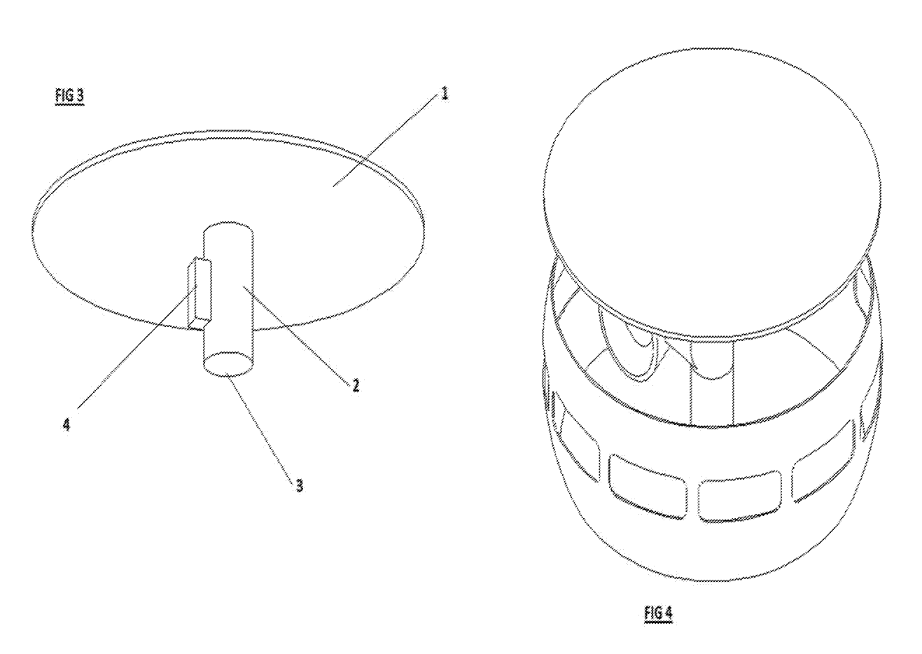

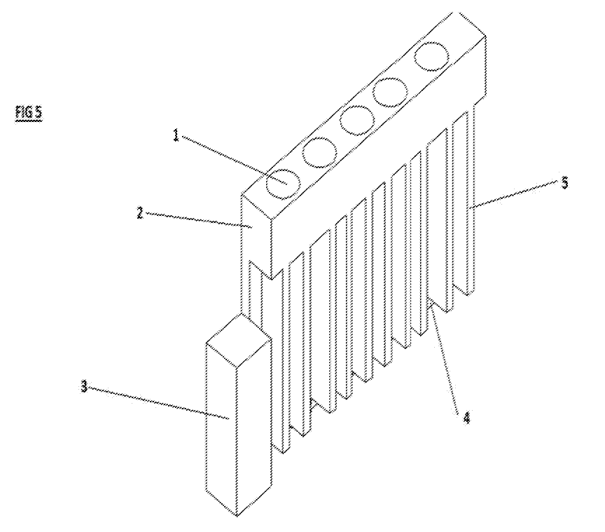

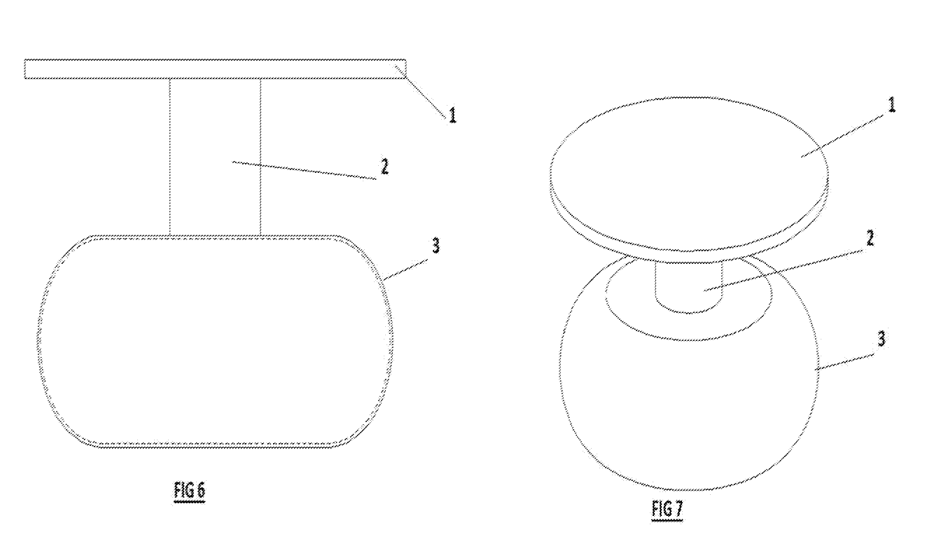

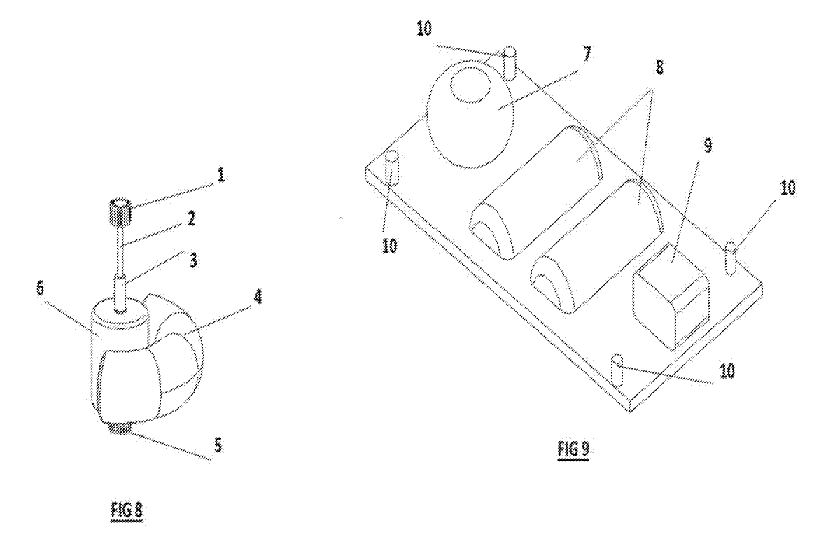

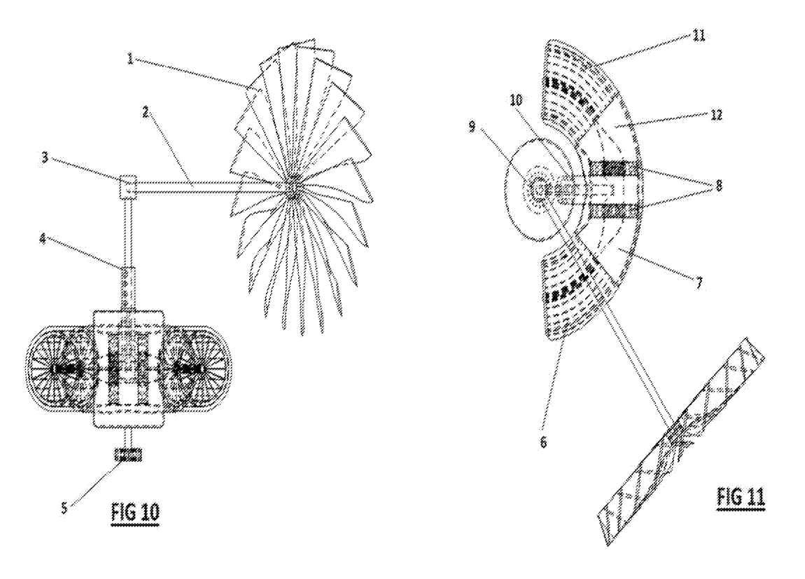

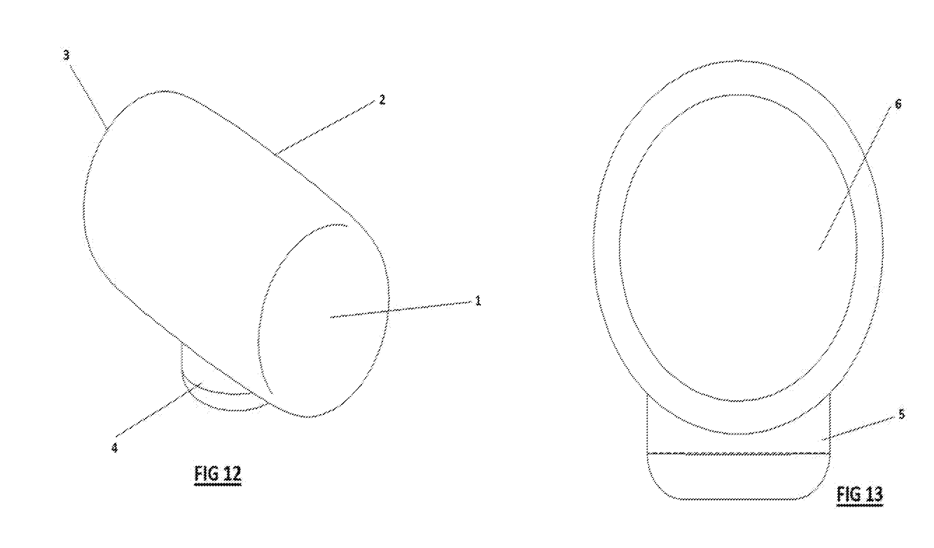

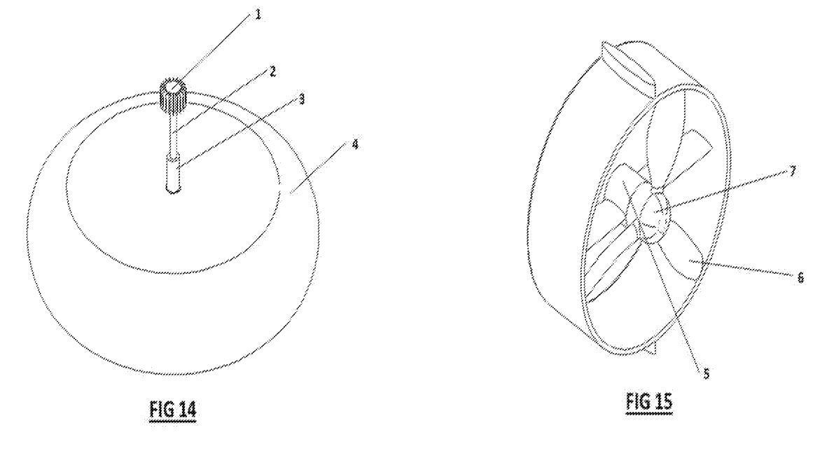

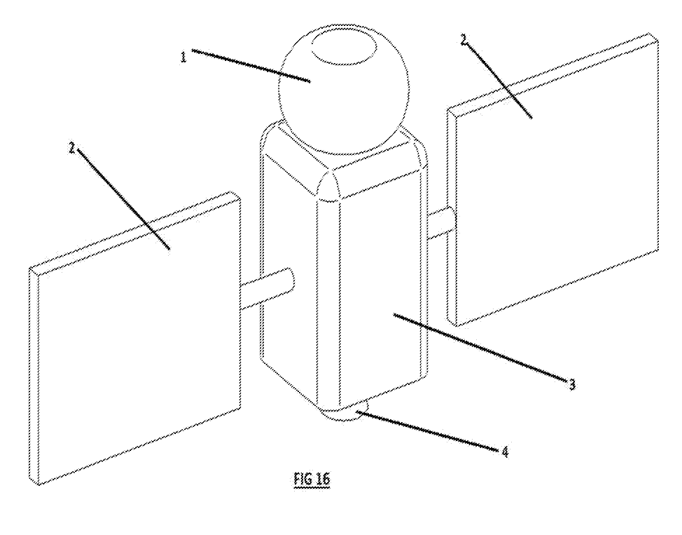

### INDUCED FLOW TURBINE WITH CRYOGENIC HELIUM

The present invention concerns the induced flow turbine with cryogenic helium technically characterized by a first heat exchanger; a nozzle; a turbine; a second heat exchanger; an electronic control circuit consisting of microcontrollers, valves and electrical switches; a heated fluid reservoir having electrical resistors embedded therein and pressurized; a thermal energy supply system; a flow induction unit consisting of a pump and an electric motor; The whole being enclosed in an insulated casing and being immersed in helium gas at very low temperature and which, when they enter into synergy, make it possible to supply electricity, mechanical energy and ensure the operation of a reversible cooling system. This system can be used to power a home, a city, an aircraft, satellite, a car, a boat or a submarine, any powered vehicle.

It is known that up to now turbine systems exist that although fulfilling the same function as the induced flow turbine system with cryogenic helium, which is the subject of the invention, exhibit a certain number of technical problems which are among others:

The high temperature required, up to thousands of degrees Celsius, to operate the thermal turbines that require a compressor and a combustion chamber.

### STATE OF PRIOR ART

WO 2010/059093 A1 describes a solar flow turbine with a nacelle, a generator actuated by a turbine. However, WO 2010/059093 A1 differs from the present invention in that the movement of the flow is vertical and that the nacelle in the terrestrial reference frame is fixed. This makes the system of WO 2010/059093 A1 less effective and presents a constraint regarding the installation of the system because the nacelle must necessarily be vertical. Moreover, the fluid in motion in the nacelle comes from the external environment, and therefore its initial temperature depends on the external environment. This further reduces the effectiveness of the system in the case of a warmer climate.

The induced flow turbine with cryogenic helium sets a fluid (gas) in motion relative to a turbine in a nacelle. No mechanical compressor is required for its operation.

Examination of state of the art especially in the field of patents has not made it possible to identify turbine systems making it possible to solve the above problems contrary to the object of the present invention:

Induced Flow Turbine with Cryogenic Helium.

### DESCRIPTION

The induced flow turbine with cryogenic helium can be used to generate electricity or mechanical power with high efficiency by inducing a current or wind that converts the energy in the form of pressure in the helium into kinetic energy and for the driving the of a turbine.

### DESCRIPTION OF BOARDS

Plate 1 shows the flow diagram of the induced flow turbine with cryogenic helium. The 12 corresponds to the first heat exchanger. The 1 corresponds to the converging nozzle. The 2 corresponds to the turbine compartment. The 3 corresponds to the second heat exchanger. The 5 corresponds to a couple of microcontroller-switch that allows connecting an electrical circuit. The 6 corresponds to the external electrical circuit. 7 corresponds to the flow induction unit consisting of a pump (4) and an electric motor (8). The 11 corresponds to the second power supply source for the flow induction unit. The 9 corresponds to an external heat source. The 10 corresponds to a solar heat plate. The 13 corresponds to the reversible cooling system.

Plate 2 represents the design of the induced flow turbine with cryogenic helium with a rotational movement. The 1 corresponds to the nacelle of the turbine. The 2 corresponds to the inlet of the turbine. The 3 corresponds to the envelope of the transmission shaft going from the turbine to the electric generator. The 4 corresponds to the second heat exchanger. The 5 corresponds to the pump. The 6 corresponds to the electric generator compartment. The 7 corresponds to the compartment of the electric motor. The 8 corresponds to the first outer casing for the protection of the turbine. The 9 corresponds to the first heat exchanger incorporated in the converging nozzle.

Plate 3 represents the design of the solar heating plate that can be used with the turbine to provide thermal energy. The 1 corresponds to the solar plate. The 2 corresponds to the reservoir of heated fluid sent to the first heat exchanger. The 3 corresponds to the external thermal energy supply unit. The 4 corresponds to the temperature control box and contains a small electric pump.

Plate 4 represents the design of the reversible cooling system. The 1 corresponds to the inlet making it possible to circulate the cooling fluid in a chamber. The 2 corresponds to the support of the small pumps in the chambers. The 3 corresponds to the compartment containing an electronic control circuit, a thermometer, and an electric mini-pump. The 4 corresponds to the ducts through which the cooling liquid that is connected to the second heat exchanger passes. 5 corresponds to the heat exchanger for transferring the energy between the cooling fluid contained in the chambers (1) and the liquid contained in the tubes connected to the second heat exchanger (4).

The plate 5 shows the design of the induced flow turbine with cryogenic helium with an additional outer shell containing the helium wherein the nacelle is immersed and assuring the thermal insulation. The 1 corresponds to the solar panel. 2 corresponds to the heated fluid reservoir. 3 corresponds to the outer envelope containing the helium and assuring the insulation of the system.

Plate 6 shows the design of the induced flow turbine with cryogenic helium used to power an electric vehicle. 1 corresponds to the electrical generator. In this case, the electric generator is outside of the protective outer shell. 2 corresponds to a transmission shaft. 3 corresponds to a rotary union for the injection of fluids into the heat exchangers located in the nacelle. 4 corresponds to the nacelle. The 5 is the electric motor of the induction flow system. 6 corresponds to the cylindrical compartment. 7 corresponds to the induced flow turbine with cryogenic helium with the outer shell containing the helium wherein the nacelle is immersed and assuring the thermal insulation. 8 corresponds to the hot fluid reservoirs in which electrical resistors are embedded. 9 corresponds to the burner using fuel to produce the exothermic source for heating a fluid which is sent to the induced flow turbine with cryogenic helium, into the first heat exchanger. 10 corresponds to the points where the electric motors are fixed to propel the vehicle.

Plate 7 shows the design of the induced flow turbine with cryogenic helium used to drive a fan. The 1 is the fan. 2 corresponds to a transmission shaft. 3 corresponds to a gear power transmission mechanism for propagating power at a 90-degree angle shaft and changing the rotational speed. 4 corresponds to a rotary union for the injection of fluids into the heat exchangers located inside the nacelle. The 5 is the electric motor of the induction flow system. 6 corresponds to the first heat exchanger. 7 corresponds to a converging nozzle. 8 corresponds to the turbines. 9 corresponds to a gear power transmission mechanism for propagating the power to a shaft at 90 degrees. 10 corresponds to a tree. 11 corresponds to the second heat exchanger. 12 corresponds to a diverging nozzle placed in front of the second heat exchanger.

Plate 8 shows the design of the induced flow turbine with cryogenic helium mounted in a nacelle of an aircraft engine. 1 corresponds to the inlet of the nacelle of the aircraft engine. 2 corresponds to the nacelle of the aircraft engine. 3 corresponds to the outlet of the nacelle of the aircraft engine. 4 and 5 correspond to a compartment into which the induced flow turbine with cryogenic helium is located. 6 corresponds to the inlet of the nacelle of the aircraft engine. It is where the fan is located.

Plate 9 shows the design of the induced flow turbine with cryogenic helium used to drive a propeller. 1 corresponds to the electrical generator. In this case the electric generator is outside of the protective outer shell. 2 corresponds to a transmission shaft. 3 corresponds to a rotary union for the injection of fluids into the heat exchangers. The 4 corresponds to the outer shell containing the helium wherein the nacelle is immersed and assuring the thermal insulation. 5 corresponds to an electric motor onto which a propeller is mounted. 6 corresponds to the propeller. 7 corresponds to the center of the propeller.

Plate 10 shows the design of the induced flow turbine with cryogenic helium used to power a satellite. 1 corresponds to the induced flow turbine with cryogenic helium. 2 corresponds to thermal solar panels capturing the sun radiations. 3 corresponds to the central part of the satellite. 4 corresponds to the satellites propulsion engine.

### DISCLOSURE OF INVENTION

The induced flow turbine with cryogenic helium consists of a converging nozzle fixed upstream of the turbine. This converging nozzle is made of a very resistant plastic material to hold the high pressure exerted by the fluid. In the converging nozzle, a heat exchanger is incorporated powered by a solar plate and an external system supplying the thermal energy. This heat exchanger is made of copper. The solar plate consists of a glass plate above and copper tubes containing the fluid heated by the sun or an exothermic source of energy. The glass plate makes it possible to insulate the tubes from the external environment and prevents heat transfer from the copper tubes to the outside by convection. The unit is under vacuum to minimize heat loss. At the bottom of the solar plate, there is a reservoir containing the fluid heated by the sun by radiation or by an exothermic and pressurized source. The walls of the tank have thermal insulation. This keeps the temperature of the fluid heated. Also in the tank are electrical resistances which allow the fluid to be heated by direct injection of electricity. These resistances are controlled by the electronic circuit of the turbine. Next to the tank is an electric pump which allows the hot fluid to be sent to the heat exchanger incorporated in the converging nozzle. Below the reservoir, there is an external energy supply system, which is an exothermic source, consisting of a reservoir containing a fuel and a burner.

Downstream of the converging nozzle there is the turbine. It is mounted on a gear-power transmission mechanism enabling the power extracted by the turbine blades to be propagated at a 90-degree angle shaft. At the back of the blades, there is a metal heat exchanger. Behind this heat exchanger there is a pump controlled by the flux induction unit. After the pump, there is a duct which guides the flow from the turbine to the outside of the nacelle.

The steel transmission shaft leaves the nacelle that contains the turbine and transmits the extracted power to a generator. The shaft is inside a plastic envelope also to reduce the drag force and avoid the Magnus effect. In this envelope is also all the wiring and ducts connecting the nacelle of the turbine to the central part where the generator and the engine are placed. The power is transmitted at 90 degrees angle to an electric generator. The generator compartment is connected to the nacelle and rotates together as a single block. This compartment is mounted on bearings and is connected to the motor by a shaft.

In the engine compartment are located the electronic control circuits and the electric motor, forming part of the flux induction unit. This compartment is fixed and is attached to the outer protective envelopes. The compartment and the outer envelopes are made of plastic. The first outer casing is perforated to allow the evacuation of the turbulences towards the outside of the latter and to prevent them from being sucked in by the turbine, maximizing the performance of the blades. The second outer shell, having thermal insulation, is added to ensure the capacity of the fluid in which the nacelle is immersed and allow its thermal insulation.

The second heat exchanger is connected to a network of small heat exchangers having chambers for cooling the helium in which the nacelle is immersed. These small heat exchangers are made of copper.

The small pumps, allowing the recirculation of fluid in the chambers, are made of plastic and mounted on small electric motors. An electronic control system and an electric mini-pump are attached to the device allowing the management of the temperature in the chamber or chambers. This system, of the second heat exchanger and the network of small heat exchangers, is reversible.

### OPERATION

The flow induction unit is composed of a pump, an electric motor, and an electronic system. These two elements make it possible to induce flow.

The movement of an object is relative. Depending on the referential, the intensity of the movement may be different. The pump allows the fluid to be aspirated through the nacelle. The electric motor increases the fluid velocity relative to the nacelle. The combination of the two is dictated by researching the peak of efficiency. At a certain flow rate, the pump becomes inefficient, and it is stopped by the electronic circuit. In another flow regime, the pump alone is sufficient. Thus the turbine sees a flow in motion. Initially, the flow induction unit is powered by using an external energy source. Then, when the turbine reaches a certain speed, the flow induction unit switches to the generator connected to the turbine via the electronic control circuit.

The turbine must at the same time provide energy and assure its relative motion with respect to the fluid. Knowing that energy cannot be created from nothing nor destroyed and that it is conserved, an additional source of energy must be found. This is achieved by the use of the solar plate and the external energy supply system. Fluid has a total pressure. The pressure itself is not energy, but by its work it produces it. This total pressure splits into two types of pressure for an incompressible fluid: static pressure and dynamic pressure related to movement. Thus, the mechanical energy of an incompressible fluid is the sum of three types of energies: that of pressure which is the ratio of the pressure to the density of the fluid; that related to the speed and that is proportional to the square of the speed and that related to the potential energy function of the elevation. Therefore, when the pressure drops, the speed and the elevation increase by neglecting the losses due to friction. The turbine and the nacelle being at constant elevation, only the speed increases in our case inside the nacelle. It exists means to transform pressure into speed without providing work that is the use of a converging nozzle. By combining a converging nozzle with a turbine and driving them beyond a certain critical speed with external energy input, it is possible to obtain enough power to both maintain the movement and provide electricity. Therefore, beyond a critical speed, the system becomes a generator in the image of an AC electric motor which becomes a generator when its rotation speed is greater than the synchronization speed.

In summary, the cold helium entering the nacelle is heated by the heat exchanger and its temperature increases. This increases the internal energy of the fluid. This internal energy is transformed into speed in the converging nozzle and turns the turbine.

After passing the turbine and lost pressure, the fluid has a lower temperature. This temperature reduction is used by the second heat exchanger to lower the temperature of the fluid in a reversible cooling system (consisting of other small heat exchangers placed in the chambers) and to cool the generator and the electric motor. After passing through the heat exchanger, the flow is warmed up and its pressure increased by a little. This makes it possible to increase the efficiency of the pump during its operation.

However, if the temperature of the chambers is less than that of the outgoing helium of the nacelle turbine, the second heat exchanger will cool the helium.

In this case, the temperature of the chamber or of the chambers makes it possible to control the temperature of the helium in which the nacelle is immersed. This is used to make the nacelle evolve in a colder environment and thus increase the efficiency of the turbine. In this case, a diffuser is placed in front of the second heat exchanger to increase the volume and thus the temperature of the helium. This is done to have a good cooling coefficient.

In fact, the lower the temperature of the fluid in which the nacelle is immersed, the more efficient the turbine will be by considering the statement about the efficiency of Carnot. Thus, the use of a cryogenic fluid will significantly increase the efficiency of the turbine.

Also, the speed of sound decreases in a cold fluid. This is used to produce shock waves by driving the nacelle at speed higher than the speed of sound thanks to the flow induction system. The use of shock waves and the phenomenon of diffusion (slowing of the flow by an increase in volume) at the entrance of the nacelle before the first heat exchanger makes it possible to increase the pressure and thus the efficiency of the turbine. A compression cone can be used to produce the shock waves. In the case of a subsonic regime, the phenomenon of diffusion alone is enough to increase the pressure. The immersion of the nacelle of the induced flow turbine in cryogenic helium makes it possible to attenuate the structural warming and the drag from shock waves because the speed of sound is low.

The speed in the nacelle is maintained at a speed that allows the turbine/generator to produce an alternating current with the right voltage and frequency. This avoids the use of an inverter. The power is held constant, the excess of electricity from the generator in case of under-utilization is returned to the electrical resistances of the pressurized hot fluid reservoir. Thus the tank acts as the battery for the turbine system.

This same device is used for an electric car with tanks having electrical resistances. The thermal energy resulting from the braking of the vehicle can be used to power the device.

Also, cryogenic helium is used to cool the gear system in the case of the induced flow turbine with cryogenic helium. Indeed, the gear system transmitting the mechanical energy coming from the turbine, due to the friction on the gears in contact, tends to heat up during transmission of high power setting. However, with cryogenic helium and the second heat exchanger, the heat from the gear mechanism is recovered and transmitted to the first heat exchanger via the reversible cooling system which is connected to the second heat exchanger.

This turbine can be used with any other type of fluid at any temperature. It does not have to be necessarily cryogenic.

1. Induced flow turbine with cryogenic helium having a nacelle; a generator turned by a turbine, characterized by the nacelle, immersed in a fluid, consisting of heat exchangers, a converging nozzle, a turbine and a pump, is connected to a cylindrical compartment into which a generator is located which is turned by the turbine located in the nacelle; a motor which is part of the flow induction unit and which, by supplying to it external energy, moves the inlet of the nacelle around an axis of rotation, thereby causing relative movement between the fluid, The inlet of the nacelle and the turbine located in the nacelle.

2. Induced flow turbine with cryogenic helium according to claim 1, characterized in that the flow induction unit inducing relative movement between a fluid and a turbine is composed of a pump and a motor which are initially run by using external energy input and which, when the turbine provides sufficient energy, shift to the turbine.

3. Induced flow turbine with cryogenic helium according to claim 1, characterized in that the motor of the flow induction unit can also be an electric generator operated by a turbine located in the nacelle.

4. Induced flow turbine with cryogenic helium according to claim 1, characterized in that the nacelle is in the static position when the pump alone is used for the operation of the turbine.

5. Induced flow turbine with cryogenic helium according to claim 1, characterized in that a fluid heated by a solar thermal plate or an exothermic energy source is fed to a heat exchanger located upstream of the turbine.

6. Induced flow turbine with cryogenic helium according to claim 1, characterized in that it is used in a reversible cooling system by means of a heat exchanger installed in the nacelle downstream of the turbine which is connected to other small Heat exchanger and which is used to cool the fluid in which the nacelle is immersed by adding a diffuser before the heat exchanger and to heat the hot fluid to be sent into a heat exchanger upstream of the turbine.

7. Induced flow turbine with cryogenic helium according to claim 1 characterized in that it makes it possible to produce mechanical energy; in the case of mechanical energy production only, the electric generator located in the cylindrical compartment is suppressed, replaced by a gear-power transmission mechanism and the turbine makes it possible to maintain the movement of the entrance of the nacelle around the axis of rotation, thus maintaining the relative movement between the fluid and the turbine in the nacelle.

8. Induced flow turbine with cryogenic helium according to claim 1, characterized in that a plurality of turbines and converging nozzles are connected in series in the nacelle and nacelles are placed in parallel around the cylindrical compartment.

9. Induced flow turbine with cryogenic helium according to claim 1, characterized in that the turbine can be of the axial or radial type and that the nacelle and the cylindrical compartment are in a single unit; the turbine is placed in the cylindrical compartment, and is mounted horizontally or vertically, has the same axis of rotation as the cylindrical compartment, the inlet of the nacelle is directly merged to the cylindrical compartment side and the nacelle outlet is at the bottom of the cylindrical compartment.

10. Induced flow turbine with cryogenic helium according to claim 1, characterized in that the nacelle is immersed in an ionized fluid and that mechanical flow control systems and electric and magnetic fields make it possible to control the flow of Fluid, to reduce the drag and to damp the turbulences produced by the relative movement of the nacelle and the fluid.

11. Induced flow turbine with cryogenic helium according to claim 1, characterized in that a magneto hydrodynamic generator is placed inside the nacelle, thus enabling the kinetic energy of the fluid to be transformed directly into electricity.

12. Induced flow turbine with cryogenic helium according to claim 1, characterized in that electrical resistors are incorporated in a pressurized hot fluid reservoir and operate during a surplus power coming from the generator, thereby storing the excess of energy in the hot tank avoiding the use of external chemical batteries.

13. Induced flow turbine with cryogenic helium according to claim 1, characterized in that the nacelle is insulated from the external environment by the second external casing which has thermal insulation and makes it possible to control the density and pressure of fluid into which the nacelle is immersed by means of valves.

14. Induced flow turbine with cryogenic helium according to claim 1, characterized in that a heat exchanger connected to the exothermic source and to the cooling system and located outside of the nacelle allows to control and to keep the temperature of the fluid uniform outside of the nacelle.

15. Induced flow turbine with cryogenic helium according to claim 1, characterized in that the nacelle receives a flow at a speed higher than the speed of sound by operating the flow induction system, increasing the pressure thus increasing the efficiency of the turbine and this without the use of an axial or centrifugal compressor.

16. Induced flow turbine with cryogenic helium according to claim 1, characterized in that an axial or centrifugal compressor is placed in the nacelle upstream of the turbine and is driven by the turbine via a shaft, increasing the efficiency of the turbine and the compression effect resulting from the shock waves at the entrance to the nacelle.

17. Induced flow turbine with cryogenic helium according to claim 1, characterized in that the inlet of the nacelle is connected to the cooling system, thus enabling the inlet of the nacelle to be cooled in the event of excessive temperature.

18. Induced flow turbine with cryogenic helium according to claim 1, characterized in that a combustion chamber is placed upstream of the turbine and makes it possible to increase the energy of the fluid turning the turbine.

19. Induced flow turbine with cryogenic helium according to claim 1, characterized in that the exit of the nacelle has a variable exhaust nozzle, thus enabling the residual energy of the fluid leaving the nacelle to be used to propel the nacelle.

20. Induced flow turbine with cryogenic helium according to claim 1, characterized in that in the nacelle there is a converging nozzle and a throttling valve which is directly placed in front of a heat exchanger, making it possible to ensure the cooling of a fluid located in the heat exchanger in the nacelle by bypassing the turbine and going through the throttling valve that lowers the temperature of the fluid.
